(19) United States
(12) Patent Application Publication
(10) Pub. No.: US 2025/0159626 A1
(43) Pub. Date: May 15, 2025

(54) METHODS FOR SUPPORTING SS/PBCH BLOCKS IN SINGLE CARRIER WAVEFORMS FOR INITIAL ACCESS

(71) Applicant: INTERDIGITAL PATENT HOLDINGS, INC., Wilmington, DE (US)

(72) Inventors: Nazli Khan Beigi, Longueuil (CA); Young Woo Kwak, Woodbury, NY (US); Moon IL Lee, Melville, NY (US); Paul Marinier, Brossard (CA)

(73) Assignee: INTERDIGITAL PATENT HOLDINGS, INC., Wilmington, DE (US)

(21) Appl. No.: 18/837,740

(22) PCT Filed: Feb. 16, 2023
(86) PCT No.: PCT/US2023/013209

§ 371 Date: Aug. 12, 2024

Related U.S. Application Data
(60) Provisional application No. 63/311,316, filed on Feb. 17, 2022.

(51) Int. Cl. H04W 56/00; H04J 13/00; H04W 74/0833

(52) U.S. Cl. CPC H04W 56/0015; H04J 13/0062; H04W 74/0833

(57) ABSTRACT

A wireless transmit/receive unit (WTRU) may be configured to receive a primary synchronization signal (PSS) scrambled with a first sequence and to determine a PSS sequence index (uₖ) associated with the PSS and a first sequence index (wᵢ) associated with the first sequence. The WTRU may be configured to determine a first parameter set based on the PSS sequence index (uₖ) and the first sequence index (wᵢ) and to send information using at least one parameter from the determined first parameter set. The first parameter set may be associated with a waveform. The first parameter set may comprise at least one of: an indication of a waveform type and an indication of a multiplexing scheme. The information may be a physical random access channel (PRACH) transmission. The WTRU may be configured to determine a first offset based on the PSS sequence index (uₖ) and the first sequence index (wᵢ).

### CROSS-REFERENCE TO RELATED APPLICATIONS

This application claims the benefit of U.S. Provisional Application No. 63/311,316, filed Feb. 17, 2022, the contents of which are incorporated herein by reference.

### BACKGROUND

A new Radio Access Network (RAN) study item on New Radio (NR) beyond 52.6 GHz has been agreed in RAN #80. This technology may be a foundation for future high data rate frameworks. For the realization of beyond 52.6 GHz systems, a resolution of key challenges due to the special channel and radiation characteristics is needed.

Considering the higher frequency bands, handling the transmission power is a challenge in NR beyond 52.6 GHz bands. While higher transmission powers may be required to overcome a channel's pathloss, a power amplifier's performance generally faces degradation in higher frequencies. Moreover, employing a downlink (DL) transmission waveform based on a cyclic prefix-orthogonal frequency division multiplexing (CP-OFDM) may require considerably high peak-to-average power ratio (PAPR) and corresponding large power back-off for signal transmission.

### SUMMARY

A wireless transmit/receive unit (WTRU) may be configured to receive a primary synchronization signal (PSS) scrambled with a first sequence. The WTRU may be configured to determine a PSS sequence index (uₖ) associated with the PSS and a first sequence index (wᵢ) associated with the first sequence. The WTRU may be configured to determine a first parameter set based on the PSS sequence index (uₖ) and the first sequence index (wᵢ). The WTRU may be configured to send information using at least one parameter from the determined first parameter set. The first parameter set may be associated with a waveform. The first parameter set may comprise at least one of: an indication of a waveform type and an indication of a multiplexing scheme. The information may be a physical random access channel (PRACH) transmission. The WTRU may be configured to determine a first offset based on the PSS sequence index (uₖ) and the first sequence index (wᵢ). The first parameter set may be determined based on the first offset. The first offset may be an index to a pre-configured table. The WTRU may be configured to receive a secondary synchronization signal (SSS) using at least one parameter from the first parameter set. The SSS may be scrambled with a second sequence. The WTRU may be configured to determine a SSS sequence index (mᵢ) associated with the SSS and a second sequence index (nⱼ) associated with the second sequence. The WTRU may be configured to determine a second parameter set based on the SSS sequence index (mᵢ) and the second sequence index (nⱼ). The WTRU may be configured to send a PRACH transmission using at least one parameter from the second parameter set. The WTRU may be configured to determine a second offset based on the SSS sequence index (mᵢ) and the second sequence index (nⱼ). The second parameter set may be determined based on the second offset. The WTRU may be configured to receive information over a physical broadcast channel (PBCH) using at least one parameter from the determined first parameter set.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example DFT-s-OFDM Block Diagram at a transmitter;

FIG. 3 is an example of Nx SC-FDMA;

FIG. 4 is an example of clustered DFT-s-OFDM;

FIG. 5 is an example of configuring PBCH and DMRS based on DFT-s-OFDM along with SSS based on CP-OFDM;

FIG. 6 is an example of an SS/PBCH block configuration in initial access with hybrid waveforms;

FIG. 7 is an example first waveform parameter set table;

FIG. 8 is an example second waveform parameter set table;

FIG. 9 is an example of an SS/PBCH block configuration in initial access with hybrid waveforms;

FIG. 10 is an example scrambling a PSS code with a cover code;

FIG. 11 is an example of synchronization time offset detection without impacts from frequency offset; and

FIG. 12 is an example of synchronization time offset mid-detection due to the impacts from frequency offset.

### DETAILED DESCRIPTION

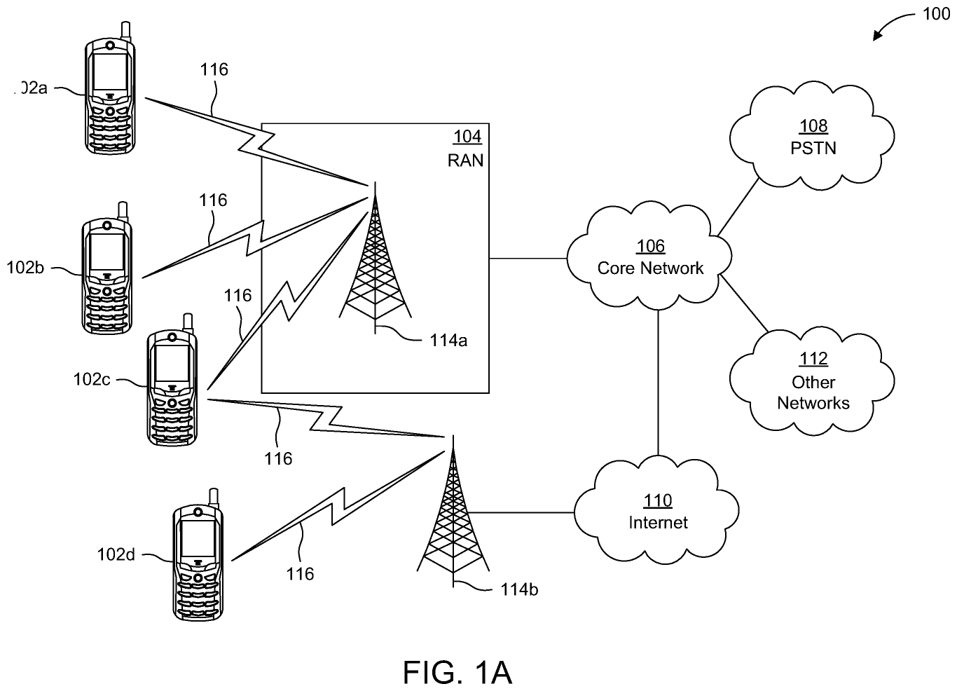

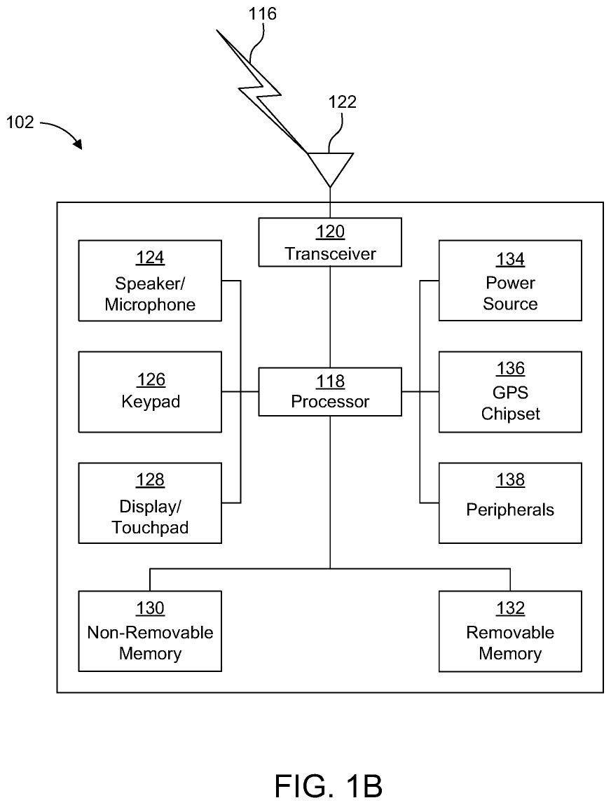

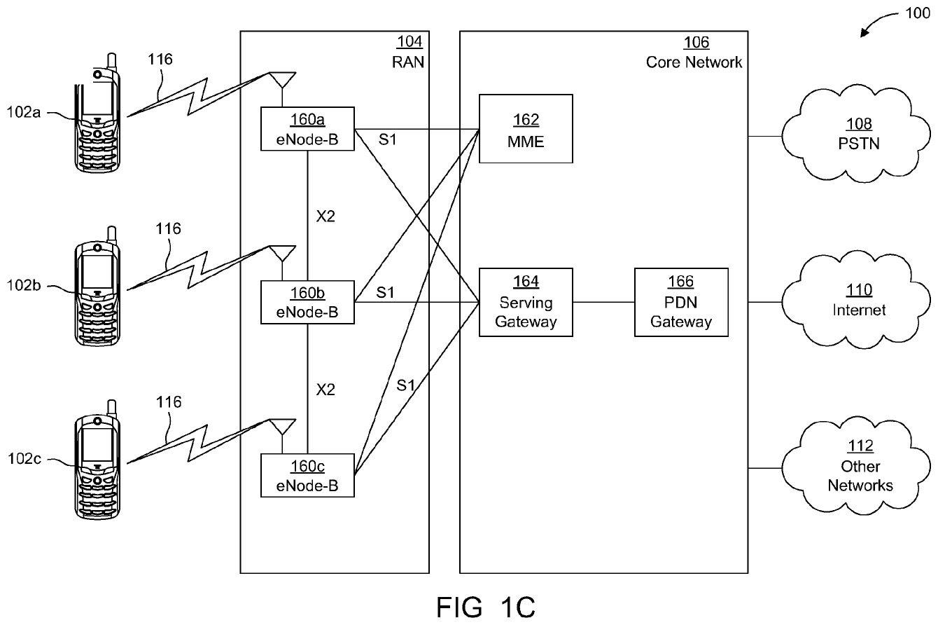

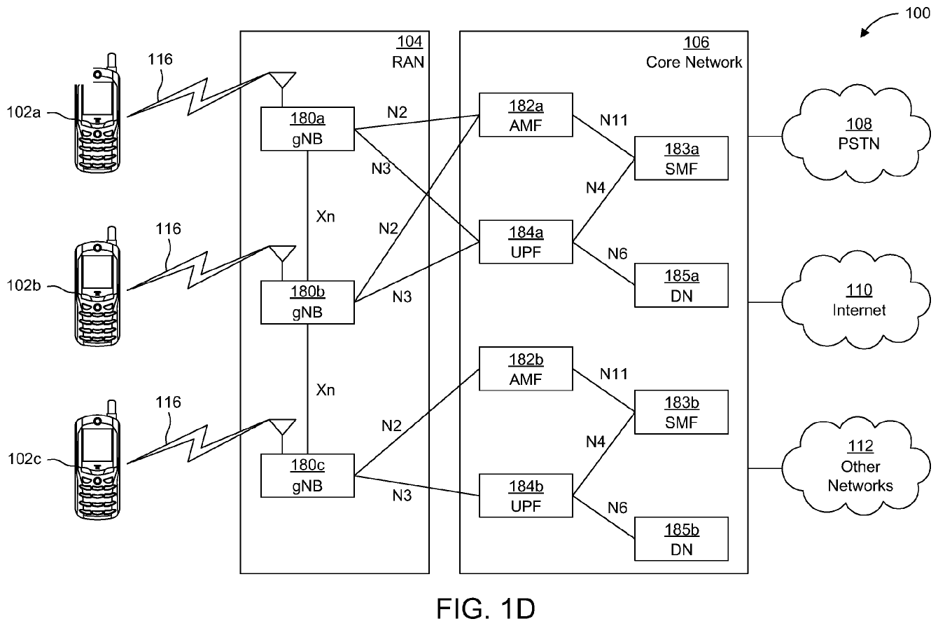

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

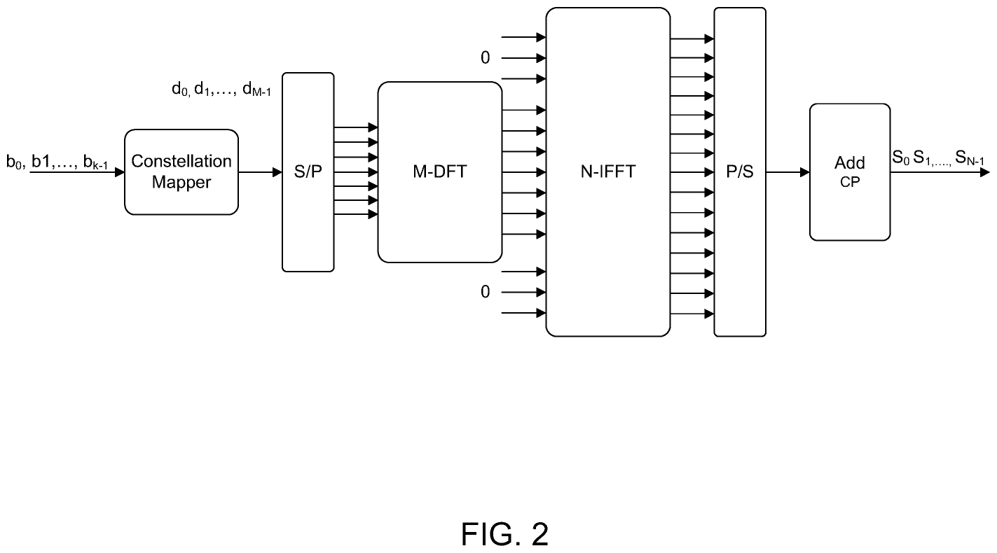

To accommodate trade-offs between the channel characteristics and the performance in power amplifiers, discrete Fourier transform-spread-orthogonal frequency division multiplexing (DFT-s-OFDM) is proposed in DL for NR beyond 52.6 GHz systems, as shown in FIG. 2. Due to single-carrier (SC) operation, DFT-s-OFDM may provide a lower PAPR resulting in efficient performance of the power amplifiers. Moreover, DFT-s-OFDM may provide performance benefits in transmissions with low modulation orders and in line of sight (LOS) environments, which is the case mostly expected in NR beyond 52.6 GHz bands.

Application of DFT-s-OFDM in downlink (DL) and specifically during the time and frequency synchronization as part of an initial access operation needs further investigation. The design of the synchronization signals (SS) including primary synchronization signals (PSS) and secondary synchronization signals (SSS) requires to be resilient through the Discrete Fourier Transform (DFT). Zadoff-Chu sequences (ZC-sequences) are known as the flexible codes in DFT-s-OFDM as the DFT of a ZC-sequence is still a ZC-sequence. However, ZC-sequences are sensitive to the frequency offsets caused by misalignments of the local oscillators. The frequency offsets may lead to misdetection of the ZC-sequence and the respective time offsets. Also, the number of valid ZC-sequences is a function of the available roots that is equal to the code-length and the cyclic shifts that is limited by the zero-correlation zone configurations.

In addition to the SS code design, the configuration of the DFT module needs further analysis. Considering the properties of the DL transmission, the Nx single carrier-FDMA (Nx SC-FDMA) and/or clustered DFT-s-OFDMA should be considered to support time and frequency synchronization in single carrier waveforms.

The following problems need to be addressed for supporting SS/PBCH blocks in DFT-s-OFDM waveforms for initial access: how to configure the DFT precoder for the SS/PBCH block transmission; how to efficiently recover the correct time offset from SS/PBCH block with ZC-sequences in a DFT-s-OFDM waveform, despite possible errors due to the frequency offsets; and how to build adequate number of sequences to account for the synchronization signals.

The design of the SS/PBCH block based on DFT-s-OFDM waveform is provided. The quasi-orthogonal sequences based on the ZC-sequences are proposed for the synchronization signals, for example, PSS and/or SSS. In addition, investigation of the configuration of the DFT precoder is needed, where waveforms based on Nx-SC-FDMA, clustered DFT-s-OFDM, and/or hybrid of them are considered. Finally, a waveform configuration based on hybrid configuration of DFT-s-OFDM and/or CP-OFDM is provided.

For a clustered SC-FDMA, after a DFT filter, the symbols may be divided into two or more subsets called clusters. Different clusters may be mapped into different clusters of RBs, possibly nonconsecutive RBs.

For N x SC-OFDM, before a DFT-precoding filter, the symbols may be divided into two or more clusters. Each cluster may go through independent DFT filters, followed by independent/separate subcarrier mapping and IFFT.

A WTRU may transmit or receive a physical channel transmission or signal (e.g. reference signal) according to at least one spatial domain filter. The term “beam” may be used to refer to a spatial domain filter.

The WTRU may transmit a physical channel transmission or signal (e.g. reference signal) using the same spatial domain filter as the spatial domain filter used for receiving a RS, such as CSI-RS, or a SS block. The WTRU transmission may be referred to as “target”, and the received RS or SS block may be referred to as “reference” or “source”. In such a case, the WTRU may be said to transmit over the target physical channel or signal according to a spatial relation with a reference to such RS or SS block.

The WTRU may transmit a first physical channel transmission or signal (e.g. reference signal) according to the same spatial domain filter as the spatial domain filter used for transmitting a second physical channel transmission or signal. The first and second transmissions may be referred to as “target” and “reference” (or “source”), respectively. In such a case, the WTRU may be said to transmit the first (target) physical channel transmission or signal according to a spatial relation with a reference to the second (reference) physical channel transmission or signal.

A spatial relation may be implicit, configured by RRC, or signaled by a MAC CE or DCI. For example, a WTRU may implicitly transmit a physical uplink shared channel (PUSCH) transmission and DM-RS of the PUSCH according to the same spatial domain filter as an SRS indicated by an SRS resource indicator (SRI) indicated in a DCI or configured by RRC. In another example, a spatial relation may be configured by RRC for an SRI or signaled by a MAC CE for a physical uplink control channel (PUCCH). Such spatial relation may also be referred to as a “beam indication”.

The WTRU may receive a first (target) downlink channel transmission or signal (e.g. reference signal) according to the same spatial domain filter or spatial reception parameter as a second (reference) downlink channel transmission or signal. For example, such association may exist between a physical channel such as a PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. The WTRU may receive an indication of an association between a CSI-RS or SS block and a DM-RS by an index to a set of TCI states configured by RRC and/or signaled by a MAC CE. Such indication may also be referred to as a “beam indication”.

A WTRU may receive a synchronization signal/physical broadcast channel (SS/PBCH) block. The SS/PBCH block (SSB) may carry one or more synchronization signals, for example one or more primary synchronization signals (PSS), and one or more secondary synchronization signals (SSS). The SSB block may be carried in a physical broadcast channel (PBCH). The PBCH may be associated with a demodulation reference signal (DMRS), wherein the DMRS sequence may be transmitted in the respective PBCH.

The synchronization signals may include one or more reference sequences. The reference sequences may be generated based on, for example, Zadoff-Chu (ZC) sequences, m-sequences, Gold sequences, or pseudo-random sequence.

Within an SSB block, the synchronization signals (e.g. PSS and/or SSS) may be surrounded by zeros. The zero-head and zero-tail sequences may be defined and/or configured before and/or after synchronization reference sequences, respectively. In an example, in an SSB block with length Nssb RBs and PSS with length Np RBs, the remaining resource blocks (e.g., Nssb RBs−Np RBs) may be configured, defined, and/or determined to be zeros.

The synchronization signals may be surrounded by RBs that carry system information as part of a PBCH or a DMRS in a PBCH. For example, in an SSB block, the resource blocks located before and after SSS RBs may include system information, PBCH, and/or DMRS in PBCH.

A WTRU may receive a PSS that is generated based on m-sequences, where the corresponding cyclic shifts may be associated with the respective physical cell IDs (PCIDs). An example of an m-sequence with length N_{MS} and cyclic shift w is provided as follows. The equation below is a non-limiting example of the m-sequence generation. One or more of those parameters may be included. The length of the sequence, cyclic shift, and choices for each parameter are examples. Other values for length of the sequence, cyclic shift, or choices may be included.

$$\begin{matrix}{x}_{w} [ n ] = 1 - 2 x ( m ) , \\ m = ( n + w ) mod {N}_{M S} \\ n = 0 , 1 , … , {N}_{M S} - 1 \\ x ( i + 7 ) = ( x ( i + 4 ) + x ( i ) ) mod 2 \\ [ \begin{matrix}x ( 6 ) & x ( 5 ) & x ( 4 ) & x ( 3 ) & x ( 2 ) & x ( 1 ) & x ( 0 ) ] = [ \begin{matrix}1 & 1 & 1 & 0 & 1 & 1 & 0\end{matrix} ]\end{matrix}\end{matrix}$$

The WTRU may receive a PSS that is generated based on Zadoff-chu (ZC) sequences. The root indexes employed in ZC-sequences may be associated with the respective PCIDs. A ZC sequence with length Nzc may have zero autocorrelation with a cyclically shifted version of itself, whereas, the cross correlation of two or more different ZC-sequence (i.e. with different roots) may be constant and as low as one over square root of Nzc. An example of the u-th root of a ZC-sequence with length Nzc is provided as follows. The equation below is a non-limiting example of the ZC-sequence generation. One or more of those parameters may be included. The length of the sequence, root index, and choices for each parameter are examples. Other values for length of the sequence, root index, or choices may be included.

$${x}_{u} [ n ] = {e}^{- j \frac{π un ( n + 1 )}{{N}_{ZC}}} , n = 0 , 1 , … , {N}_{ZC} - 1$$

A WTRU may receive an SSS that is generated based on Gold sequences, where the cyclic shifts may be associated with the respective physical cell IDs (PCIDs). Alternatively, the WTRU may receive an SSS that is generated based on Zadoff-chu (ZC) sequences. The root indexes employed in ZC-sequences may be associated with the respective PCIDs.

During initial access and/or initial synchronization, a WTRU may monitor, receive, or attempt to decode an SSB block.

During initial access and/or initial synchronization a WTRU may monitor, receive, or attempt to decode a PSS. The WTRU may perform band scans based on the synchronization raster. Upon successful detection of a PSS, the WTRU may determine the time offset and carrier frequency offset. The WTRU may determine a physical cell ID (PCID) based on at least the detected PSS sequence. The WTRU may generate the time and frequency grid as the OFDM reference grid. The WTRU may monitor to detect a SSS. The WTRU may determine system parameters such as PCID, symbol and/or frame timing. The WTRU may receive, detect, and/or decode the PBCH and/or the DMRS in a PBCH. The WTRU may determine system information, for example, system frame number and SSB block index.

Upon successful detection and/or decoding of an SSB block, the WTRU may use or employ the determined time and/or frequency synchronization, system information, and/or the symbol and/or frame timing. The WTRU may perform one or more of: control resource set (e.g. CORESET #0) and PDCCH detection (e.g. Type-0 PDCCH detection), system information block (SIB) reception, physical random access channel (PRACH) transmission, or channel measurement.

The WTRU may receive and/or monitor a CORESET #0 and Type-0 PDCCH search space based on determined configurations, for example, a number of symbols, a number of RBs, a multiplexing pattern, and RB offsets.

The WTRU may receive one or more of system information and/or configuration based on decoding one or more system information blocks (SIBs).

The WTRU may perform PRACH transmission in determined PRACH resources/sequences.

The WTRU may perform a channel measurement (e.g. radio link monitoring (RLM) and report information based on one or more of PUCCH, PUSCH and PRACH.

Considering a new waveform in downlink (DL) transmission, a concept of single carrier may not be flexible enough to support multi-WTRUs and/or multi-content DL transmission. Therefore, the WTRU may receive an initial access signal in a new waveform based on one or more multiplexing schemes, for example, Nx single carrier-frequency domain multiple access (Nx-SC-FDMA) and/or clustered DFT-s-OFDMA.

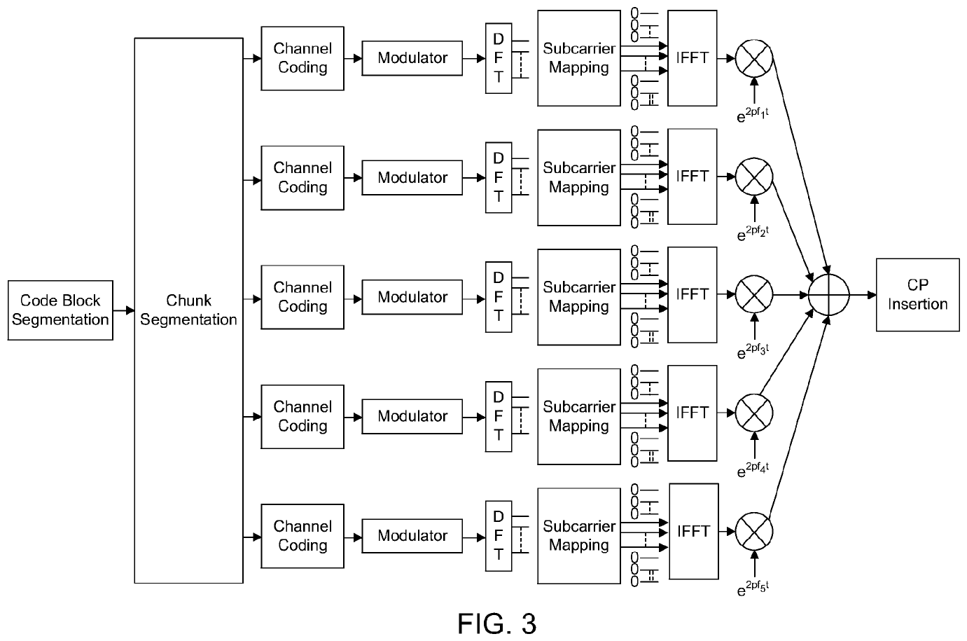

In an example, independent and/or separate DFT precoding modules may be used for respective sub-bands in a Nx-SC-FDMA multiplexing scheme, as shown in FIG. 3. One or more values as the number of independent DFT precoding modules may be used, defined, configured, or determined, for example, based on the number of WTRUs and/or respective sub-bands. One or more values as the DFT size of the DFT precoding modules may be used, defined, configured, or determined, for example, based on the respective sub-bands.

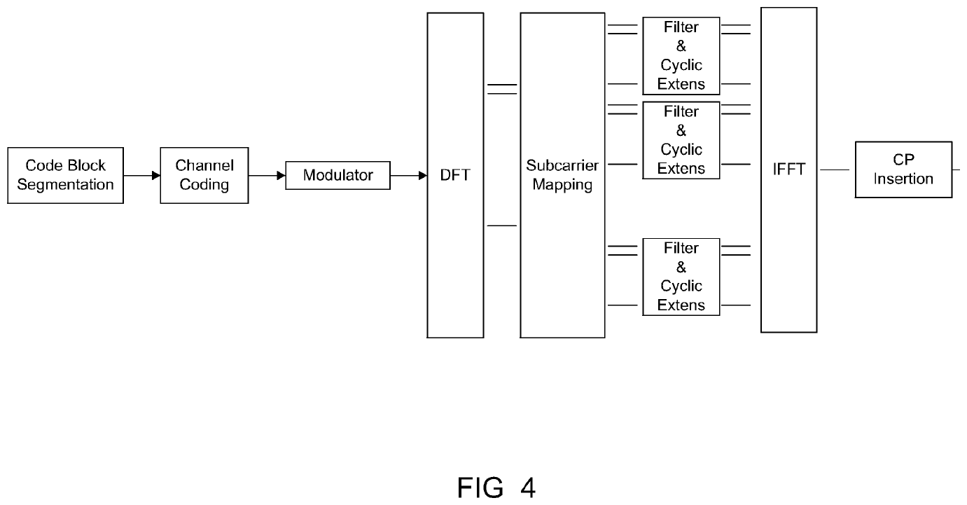

In an example, multiple DL transmissions may be considered in a clustered DFT-s-OFDMA multiplexing scheme by supporting multiple frequency domain clusters with a frequency domain gap between two clusters and an application of clusters' specific filters, as shown in FIG. 4. One or more values as the number of clusters and/or cluster sizes may be used, defined, configured, or determined.

When a single-carrier based waveform (e.g. clustered DFT-s-OFDM, Nx SC-FDMA, DFT-s-OFDM) is used, one or more DFT precoders may be used for a set of modulated symbols mapping onto a set of subcarriers scheduled for one or more WTRUs before IFFT and CP insertion. A cluster may be used for a single carrier based waveform.

When a single DFT precoder is used for a set of modulated symbols for a WTRU, a cluster may be a subset of modulated symbols which maps to consecutive subcarriers in frequency (e.g. local subcarrier group or subcarriers belong to consecutive RBs). A cluster may be a local subcarrier group which may be used for DL/UL transmission. The number of clusters may correspond to the number of subsets of modulated symbols which may map to different local subcarrier groups.

When one or more DFT precoders is used for a set of modulated symbols for a WTRU, a cluster may be a subset of modulated symbols associated with the same DFT precoder. Each cluster may be associated with a DFT precoder. For example, when N DFT precoders are used for a waveform (e.g. Nx-SC-FDMA), it may be considered as N clusters are used for the waveform.

DFT precoder may be interchangeably used with DFT spreader, DFT block, DFT process, DFT operation, and DFT pre-processing. In addition, cluster may be interchangeably used with subcarrier group, local subcarrier group, frequency resource group, RB group, PRB group, and consecutive PBR group. DFT size may be interchangeably used with cluster size, and still consistent with this disclosure and proposed solutions.

New waveform may be interchangeably used with one or more of DFT-s-OFDM, single carrier-frequency domain multiple access (SC-FDMA), Nx-SC-FDMA, clustered DFT-s-OFDM, single carrier-quadrature amplitude modulation (SC-QAM), single carrier-frequency domain equalization (SC-FDE), filter bank multi-carrier (FBMC) and universal filtered multi-carrier (UFMC), and still consistent with this disclosure and the proposed solutions.

A WTRU may determine a waveform for initial access and/or channels used for initial access (e.g. PSS, SSS, and/or PBCH, and PDCCH for SIB), where the determined waveform may be based on a hybrid of CP-OFDM and a new waveform.

In an example, a WTRU may determine that a PSS is based on a new waveform (e.g. DFT-s-OFDM or Nx-SC-FDMA) if, for example, the synchronization sequence associated with the PSS is based on a first sequence type (e.g. ZC-sequence). The WTRU may determine that a PSS is based on CP-OFDM if, for example, the PSS is based on a second sequence type (e.g. m-sequence).

In a case where a WTRU determines that the PSS is transmitted in a new waveform multiplexing pattern, the WTRU may determine the DFT size for Nx SC-FDMA and/or number of clusters for clustered DFT-s-OFDM. In an example, one or more DFT sizes and/or number of clusters may be used, defined, configured, or determined via a higher layer signaling (e.g. SIB, RRC, and/or MAC-CE) and/or a DCI, for example for non-initial access SSB detections. In an example, full or partial configuration information for waveform parameters for the PSS may be pre-defined or pre-configured when the WTRU receives or detects a respective SSB block in a new waveform multiplexing scheme.

In an example, one or more DFT sizes may be used, defined, configured, or determined for PSS monitoring, detection, and/or decoding, where the DFT size may be associated with a synch raster length in a frequency domain (e.g. synch raster step size) that is equal to GSCN or respective integer multiples (e.g. 12 RBs). In an example, a center-frequency in the DFT precoder may be used, defined, configured, or determined. As such, the center-frequency in the DFT precoder may be associated with the center frequency of the respective SSB block (e.g. resource element RE=#0 (subcarrier #0) of resource block RB #10 of the SSB block).

One or more waveform parameter sets may be used, defined, configured, or determined for monitoring and/or detecting the SSS, PBCH, and/or DMRS in the PBCH in the respective SSB block.

One or more waveform parameter sets may be used, defined, configured, or determined. The waveform parameters may include, for example: a waveform multiplexing scheme, DFT size, number of clusters, cluster size, minimum offset between clusters. A combination of such parameters may be referred to as a waveform parameter set.

In an example, a WTRU may determine that an SSS is transmitted based on a first waveform (e.g. DFT-s-OFDM), where the respective waveform parameter set may be used, defined, configured, or determined for defining the DFT precoder. The WTRU may determine symbol-level or resource-level waveform parameters for the PBCH and/or DMRS in the PBCH, where the respective waveform parameter set may be used, defined, configured, or determined for defining the DFT precoder.

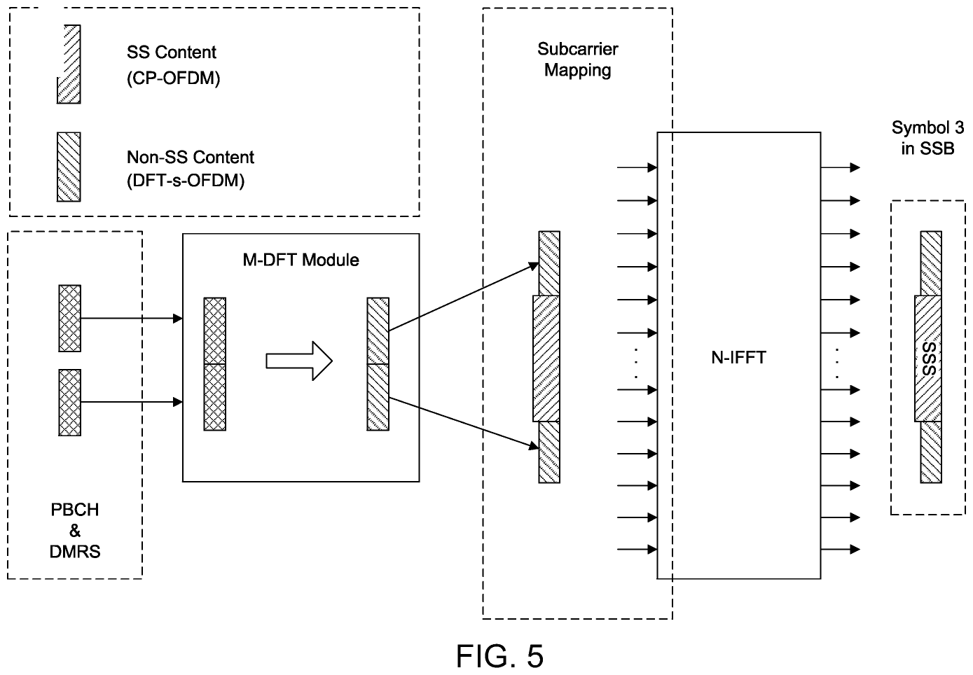

In an example, as shown in FIG. 5, a WTRU may determine that an SSS is based on a first waveform (e.g. CP-OFDM), whereas the PBCH and/or DMRS in the PBCH are based on a second waveform (e.g. DFT-s-OFDM). A third symbol in the SSB block (Symbol 3 in SSB) is shown as an example of an SSB symbol including an SSS along with a PBCH and/or DMRS in the PBCH. The WTRU may determine the waveform parameter set corresponding to the SSS, PBCH, and/or DMRS in the PBCH. Based on the determined waveform parameter set, the WTRU may determine the subcarrier de-mapping to detect and/or recover the SSS and PBCH and/or DMRS in the PBCH.

In an example, the WTRU may determine the waveform parameter set for the SSS, PBCH, and/or DMRS in the PBCH based on a PSS and a detected cover code associated with the PSS. In an example, one or more DFT sizes and/or number of clusters may be used, defined, configured, or determined via a higher layer signaling (e.g. SIB, RRC, and/or MAC-CE) and/or a DCI, for example for non-initial access SSB detections and/or once in CONNECTED mode.

In an example, a WTRU may determine a waveform for a synchronization (synch) signal (e.g. PSS or SSS) based on physical cell-ID (PCID) determined based on the sequence number of the PSS and/or SSS. For example, a first subset of PCID may be associated with a first waveform (e.g. OFDM) and a second subset of physical cell-ID may be associated with a second waveform (e.g. DFT-s-OFDM). The subset of PCIDs associated with a waveform may be pre-defined. The subset of PCIDs associated with a waveform may be determined based on the sequence of the PSS. For example, N sequences may be used for the PSS and a first sequence of the PSS may be associated with a first waveform and a second sequence of the PSS may be associated with a second waveform.

Herein, a signal may be interchangeably used with one or more of the following: sounding reference signal (SRS); channel state information-reference signal (CSI-RS); demodulation reference signal (DM-RS); phase tracking reference signal (PT-RS); synchronization signal block (SSB); synchronization signal (PSS, SSS); tracking reference signal (TRS); and positioning reference signal (PRS).

Herein, a channel may be interchangeably used with one or more of following: physical downlink control channel (PDCCH); physical downlink shared channel (PDSCH); physical uplink control channel (PUCCH); physical uplink shared channel (PUSCH); physical random access channel (PRACH) physical sidelink channels (e.g. PSSCH, PSCCH, PSFCH).

Herein, operation with or without a shared spectrum channel access may be interchangeably used with unlicensed or licensed bands, respectively. The term unlicensed spectrum may be used to refer to license exempt spectrum and lightly licensed spectrum.

Herein, the terms CORESET #0, Type0-PDCCH, PDCCH for SIB, PDCCH common search space for SIB, and/or SIB1 may be used interchangeably and consistent with this disclosure.

Configuration of an SS/PBCH block in initial access with hybrid waveforms of DFT-s-OFDM and CP-OFDM is disclosed.

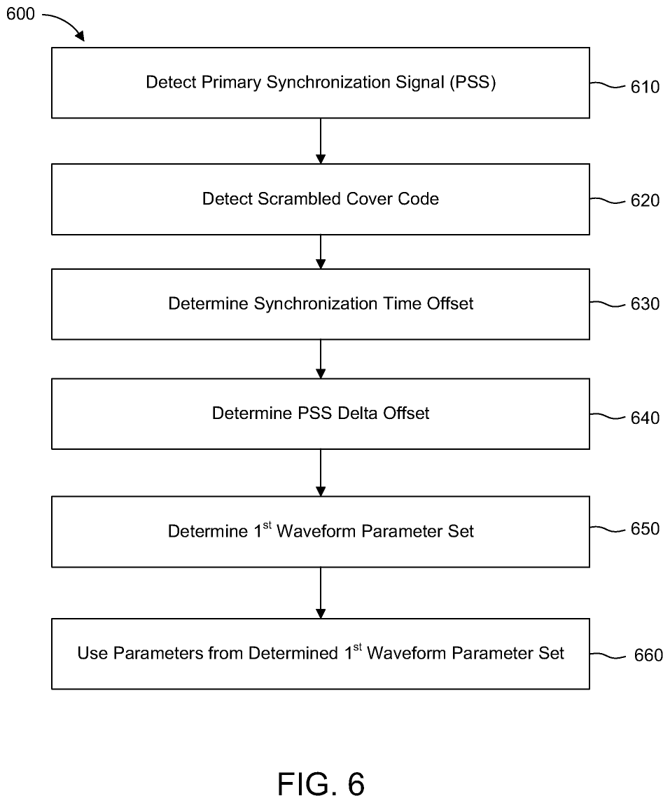

A WTRU may receive an SS/PBCH block where the synchronization signals are transmitted based on a hybrid of DFT-s-OFDM and CP-OFDM waveforms, as shown in FIG. 6.

The WTRU may monitor and/or detect a PSS (610). For example, the WTRU may detect a sequence with a root index or cyclic shift uₖ among u₁, . . . , uₚ based on a DFT-s-OFDM waveform (e.g. Zadoff-Chu sequence) or a CP-OFDM waveform (e.g. m-sequence).

The WTRU may determine a set of candidate cover codes associated with the detected PSS uₖ. For example, the sum of the detected PSS root index uₖ and PSS delta offset δ_PSS (0<δ_PSS≤M) (i.e., wₗ=uₖ+δ_PSS) may be used as the set of candidate cover codes (i.e., uₖ₊₁, . . . , u_{k+M}) associated with the detected PSS.

The WTRU may detect a scrambled cover code wᵢ in the detected PSS resource among uₖ₊₁, . . . , u_{k+M} sequences (620). Upon successful detection of the cover code, the WTRU may determine the synchronization time offset jointly based on the detected PSS uₖ and cover code wᵢ (630).

The WTRU may determine a delta-offset value δ_PSS based on the root index in the cover code (640). For example, the delta offset value δ_PSS may be δ_PSS=wᵢ−uₖ.

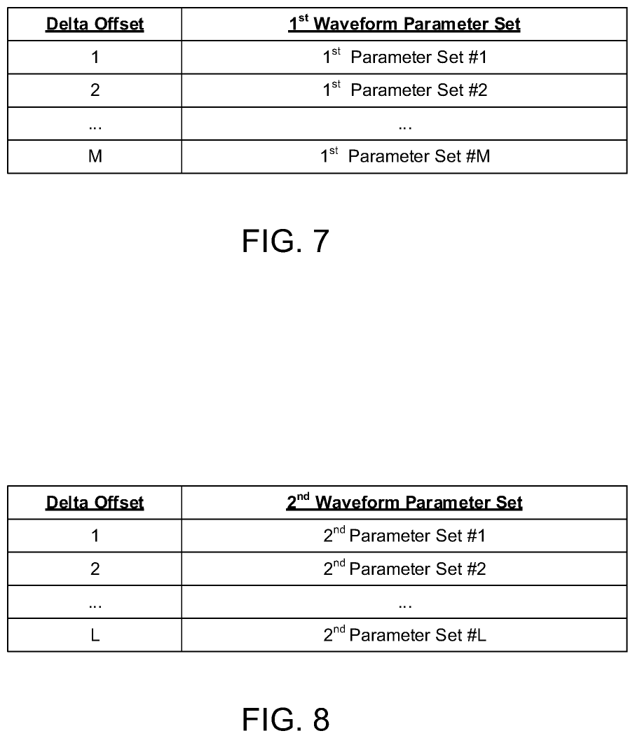

The WTRU may utilize the determined delta-offset value δ_PSS and a configured index (e.g. DFT index or delta offset index) defining a first waveform parameter set to determine a 1^{st} waveform parameter set to use (650). The first waveform parameter set may be used for the SSS and PBCH. The first waveform parameter set may comprise a number of parameter sets (e.g. 1^{st} parameter set #1, 1^{st} parameter set #2, . . . , 1^{st} parameter set #M), and may correspond to delta offsets 1, . . . , M, as shown in FIG. 7. A first waveform parameter set may comprise, for example, a multiplexing scheme, DFT size, number of clusters, and cluster size. The delta-offset values may be configured as part of the SS/PBCH block configuration. In an example, the WTRU may determine that the SSS is transmitted in CP-OFDM or in Nx-SC-FDMA, whereas the PBCH and DMRS may be transmitted in clustered DFT-s-OFDM. The WTRU may determine the respective parameters based on the waveform and multiplexing schemes for the SSS, PBCH, and DMRS.

The WTRU may utilize the parameters from the determined 1^{st} waveform parameter set (660). For example, the WTRU may use the parameters to detect the SSS. For example, the WTRU may detect a sequence with root index or cyclic shift mᵢ among m₁, . . . , mₛ.

After detecting the SSS, the WTRU may determine a set of candidate cover codes associated with the detected SSS mᵢ. For example, the sum of the detected SSS root index mᵢ and SSS delta offset δ_SSS (0<δ_SSS≤L) (i.e., nⱼ=mᵢ+δ_SSS) may be used as the set of candidate cover codes (i.e., mᵢ₊₁, . . . , m_{i+L}) associated with the detected SSS.

The WTRU may detect a cover code that is scrambled with the detected SSS and determine a delta-offset value δ_SSS based on the root index in the cover code. Upon successful determination of the delta-offset value δ_SSS, the WTRU may determine a second set of parameters based on a second parameter set. The second parameter set may comprise a number of parameter sets (e.g. 2^{nd} parameter set #1, 2^{nd} parameter set #2, . . . 2^{nd} parameter set #L), as shown in FIG. 8. The WTRU may use the determined SSS delta offset value δ_SSS to determine the 2^{nd} parameter set to use.

The WTRU may determine at least one of the following based on the second parameter set: physical cell ID, license regime, PBCH and DMRS properties, SSB index indication >64, CORESET #0 MUX patterns, PRACH resource configurations, and Q parameter indication. In an example, the WTRU may determine a set of candidate quasi-orthogonal sequences for the SSS. The SSS sequence (e.g. Gold sequence) and the cover signature (e.g. Zadoff-Chu sequence) may be multiplied symbol-by-symbol. The WTRU may determine a greater number of available SSS sequences and respective associated PCIDs. The WTRU may utilize the determined first waveform parameter set to detect the PBCH and PBCH DMRS.

In an embodiment, a WTRU may receive an SSB block where the synchronization signals may be transmitted based on a hybrid of DFT-s-OFDM and CP-OFDM waveforms.

The WTRU may monitor, receive, or attempt to decode a PSS in a respective SSB block. For example the WTRU may detect a sequence with a root index or a cyclic shift uₖ among u₁, . . . , uₚ based on a DFT-s-OFDM waveform (e.g. Zadoff-Chu sequence) or CP-OFDM waveform (e.g. m-sequence). The WTRU may determine the waveform multiplexing scheme based on the reference sequence used in the detected PSS. For example, if the WTRU detects the PSS based on a first reference sequence (e.g. Zadoff-Chu sequence), the WTRU may determine a first waveform for the PSS (e.g. new waveform). If the WTRU detects the PSS based on a second reference sequence (e.g. m-sequence), the WTRU may determine a second waveform for the PSS (e.g. CP-OFDM) without application of IDFT.

In the case where the WTRU detects the PSS based on a first waveform (e.g. new waveform), the WTRU may apply a corresponding decoder (e.g. IDFT) before PSS detection or detect the PSS by assuming different sequences (e.g. the DFT of a ZC-sequence is another ZC-sequence, i.e. a ZC sequence and its DFT are time-scaled conjugates of each other).

One or more root indexes and/or cyclic shifts (e.g. {u₁, . . . , uₚ}) may be used, defined, configured, or determined for the sequence generation in the PSS. Upon successful detection of the PSS, the WTRU may determine the root index and/or cyclic shift (e.g. uₖ among {u₁, . . . , uₚ}) corresponding to the reference sequence in the respective PSS.

Herein, the terms root index and cyclic shift, in generating the reference sequences, may be used interchangeably but still consistent with this disclosure.

In an embodiment, one or more cover codes may be used, defined, configured, or determined, where the cover codes may be associated with the determined PSS. For example, the root index and/or cyclic shift in the cover codes may be associated with the determined PSS uₖ. The cover code may be scrambled and/or symbol-by-symbol multiplied with the PSS sequence. The cover codes may be selected so that PSS may be detected with no interference and/or impact from the cover code. In an example, orthogonal and/or quasi-orthogonal sequences may be used as the cover code. For example, if the PSS is based on ZC-sequences with root index uₖ, the cover code may be generated based on a ZC-sequence with root index different from the respective PSS (e.g. wᵢ≠uₖ).

In an embodiment, a WTRU may determine a set of candidate cover codes associated with the detected PSS uₖ. In an example, the WTRU may use a reference table that includes the set of candidate cover codes based on the determined PSS. In an example, the WTRU may use the sum of the detected PSS root index uₖ and PSS delta offset δ_PSS (0<δ_PSS≤M) (i.e. wₗ=uₖ+δ_PSS) as the set of candidate cover codes (i.e. uₖ₊₁, . . . , u_{k+M}) associated with the detected PSS.

The WTRU may monitor, receive, or attempt to decode the cover code that is scrambled with the respective PSS. Upon successful detection of the cover code, the WTRU may detect the root index of the cover code wᵢ.

In an embodiment, one or more waveform parameter sets may be used, defined, configured, or determined for monitoring, detecting, and/or decoding the SSS, PBCH, and/or DMRS in the PBCH. The WTRU may determine the respective waveform parameter sets based on the cover code. As such, the combination of the PSS and associated cover code may be used to determine the corresponding waveform parameter set.

Upon successful detection of the cover code, the WTRU may detect the synchronization time offset jointly based on the detected PSS uₖ and cover code wᵢ.

In an example, a WTRU may determine the delta offset value based on the root index in the PSS and cover code (e.g. δ_PSS=wᵢ−uₖ). The WTRU may use the index associated to the determined delta offset value to determine a first set of parameters including the waveform parameter sets for the SSS, PBCH, and/or DMRS in the PBCH. The association of the delta offset values and corresponding index values may be used, defined, configured, or determined as part of SSB block configuration.

In an embodiment, a WTRU may determine a first number of DFT sizes and/or a first number of clusters for a part of an SSB block (e.g. SSS, PBCH, and/or DMRS in PBCH that is transmitted in the same symbol along with the SSS). The WTRU may determine a second number of DFT sizes and/or a second number of clusters for other parts of the SSB block (e.g. PBCH and/or DMRS in PBCH) based on at least one of the waveform parameter sets and/or higher layer configuration.

In an example, a WTRU may determine that the SSS is transmitted based on a first waveform (e.g. CP-OFDM), whereas the PBCH and/or DMRS in the PBCH are transmitted based on a second waveform (e.g. clustered DFT-s-OFDM). The WTRU may determine the respective waveform parameters based on the waveform parameter sets and/or an index table for SSS, PBCH, and/or DMRS in PBCH.

The WTRU may determine a waveform parameter for the SSS, PBCH, and/or PBCH DMRS in a symbol-level and/or resource level configuration.

The waveform parameter may be a waveform multiplexing scheme. For example, a WTRU may determine if the waveform multiplexing scheme is based on CP-OFDM or the single-carrier based waveform (e.g. clustered DFT-s-OFDM, Nx-SC-FDMA, DFT-s-OFDM) is used.

The waveform parameter may be a number of clusters. For example, a WTRU may determine the number of clusters used, defined, configured, or determined for the respective downlink channel.

The waveform parameter may be a DFT size of cluster/cluster size. For example, a WTRU may determine the DFT size for the respective clusters.

The waveform parameter may be a bitmap of clusters and/or waveform multiplexing types. In an example, a WTRU may determine the waveform and/or clusters used or determined based on a bitmap. For example, the WTRU may determine an index and/or codepoint that may indicate a bitmap of one or more DFT blocks and/or one or more clusters. The WTRU may use the bitmap for configuring and/or determining the DFT precoder's properties.

In an embodiment, a WTRU may determine the waveform parameter sets for the SSS, PBCH, and/or DMRS in the PBCH. The WTRU may monitor, receive, or attempt to decode the SSS, PBCH, and/or DMRS in the PBCH in the respective SSB block and based on the determined waveform parameter sets.

In an embodiment, a WTRU may perform channel measurements based on the cover codes associated with the PSS (e.g. synchronization time and frequency offsets, and radio link monitoring (RLM)) and may report the information based on one or more of a PUCCH, PUSCH and PRACH. For example, the WTRU may use the channel measurements based on the cover codes to determine the misdetection in synchronization time offsets based on the PSS, for example, due to the impact of frequency offsets.

Upon successful detection of a PSS and/or an associated cover code, an SSS may be detected based on a configured or determined waveform parameter set. In an embodiment, a WTRU may monitor, receive, or attempt to decode the SSS in the respective SSB block. The WTRU may determine the waveform multiplexing parameters based on the determined waveform parameter set and the combination of PSS and respective cover code.

For example, if a WTRU determines a first waveform for the SSS (e.g. new waveform), the WTRU may determine the first reference sequence (e.g. Zadoff-Chu sequence). If the WTRU determines a second waveform for the SSS (e.g. CP-OFDM), the WTRU may determine a second reference sequence (e.g. Gold sequence) without application of IDFT.

In a case where the WTRU detects the SSS based on a first waveform (e.g. new waveform), the WTRU may apply a corresponding decoder (e.g. IDFT) before SSS detection and/or detect the SSS by assuming different sequences (e.g. the DFT of a ZC-sequence is another ZC-sequence, i.e. a ZC sequence and its DFT are time-scaled conjugates of each other).

One or more cyclic shifts (e.g. {m₁, . . . , mₛ}) may be used, defined, configured, or determined for the sequence generation in the SSS. Upon successful detection of the SSS, a WTRU may determine the cyclic shift (e.g. mᵢ among {m₁, . . . , mₛ}) corresponding to the reference sequence in the respective SSS.

In an embodiment, one or more cover codes may be used, defined, configured, or determined. The cover codes may be associated with the determined SSS. For example, the root index and/or cyclic shift in the cover codes may be associated with the determined SSS mᵢ. The cover code may be scrambled and/or symbol-by-symbol multiplied with the SSS sequence. The cover codes may be selected so that the SSS may be detected with no interference and/or impact from the cover codes. In an example, orthogonal and/or quasi-orthogonal sequences may be used as the cover code. For example, if the SSS is based on Gold sequences with cyclic shift mᵢ, the cover code may be generated based on a ZC-sequence. In another example, if the SSS is based on ZC-sequences with root index mᵢ, the cover code may be generated based on a ZC-sequence with root index different from the respective SSS (e.g. nⱼ≠mᵢ).

In an embodiment, a WTRU may determine a set of candidate cover codes associated with the detected SSS mᵢ. In an example, the WTRU may use a reference table that includes the set of candidate cover codes based on the determined SSS. In another example, the WTRU may employ the sum of the detected SSS root index mᵢ and SSS delta offset δ_SSS (0<δ_SSS≤L) (i.e. nⱼ=mᵢ+δ_SSS) as the set of candidate cover codes (i.e. mᵢ₊₁, . . . , m_{i+L}) associated with the detected SSS.

The WTRU may monitor, receive, or attempt to decode the cover code that is scrambled with the respective SSS. Upon successful detection of the cover code, the WTRU may detect the root index of the cover code nⱼ.

In an embodiment, one or more system parameter sets may be used, defined, configured, or determined and each parameter set may be associated with a mode of operation. For example, if a WTRU detects or determines a first parameter set, the WTRU may perform a first mode of operation associated with the first set of parameters (e.g. system parameters). If the WTRU detects a second parameter set, the WTRU may perform a second mode of operation associated with the second set of parameters (e.g. system parameters).

The WTRU may determine the respective parameter sets based on the cover code. The combination of the SSS and the associated cover code may be used to determine the corresponding parameter set.

In an example, a WTRU may determine a delta offset value between the root indexes in the SSS and cover code (e.g. δ_SSS=nⱼ−mᵢ). The WTRU may use the index associated with the determined delta offset value to determine a second set of parameters indicating system parameters and/or respective modes of operation. The association of the delta offset values and corresponding index values may be used, defined, configured, or determined as part of SSB block configuration.

In an embodiment, upon successful detection and/or decoding of a cover code associated to the SSS, a WTRU may use the root index and/or cyclic shift corresponding to the cover code to extend the number of available sequences for the SSS. The WTRU may determine one or more operating parameters (e.g. PCID) based on the association and/or combination of the detected SSS and respective cover code. Therefore, a larger SSS sequence set and/or a larger number of available PCIDs may be used, defined, configured, or determined. In an example, the WTRU may determine that the number of SSS sequences and/or the number of available PCIDs may increase relative to the number of sequences used in the cover code.

The WTRU may determine at least one of the following system parameters and/or respective modes of operation based on the combination of SSS and the associated cover code: SSS larger sequence set; license regime; Q parameter; maximum number of candidate SSB positions; discovery burst transmission window (DBTW); PBCH reception; SSB block configuration; CORESET #0 and Type-0 PDCCH search space monitoring; sensing before transmission; and duplex mode.

The WTRU may determine a SSS larger sequence set based on the combination of the SSS and an associated cover code. In an example, a WTRU may determine an extended number, quantity, and/or choices of one or more operating parameters (e.g. PCIDs) that are associated with the detected SSS, based on a combination and/or association of the SSS and the respective cover code. For example, the WTRU may determine a set of candidate quasi-orthogonal sequences for the SSS, where the SSS sequence (e.g. Gold sequence) and the cover signature (e.g. Zadoff-Chu sequence) may be multiplied symbol-by-symbol. The WTRU may determine a larger number of available SSS sequences and respective associated PCIDs.

The WTRU may determine a license regime based on a combination of the SSS and an associated cover code. For example, when a WTRU detects a first combination of the SSS and respective cover code (e.g. index corresponding to the delta offset), the WTRU may determine the license regime in a first mode of operation. When the WTRU detects a second combination of the SSS and respective cover code, the WTRU may determine the license regime in a second mode of operation. A channel access operation may be determined based on the license regime. For example, a WTRU may perform channel access without shared spectrum operation if the spectrum is licensed. The WTRU may perform channel access with shared spectrum operation if the spectrum is unlicensed.

The WTRU may determine a Q parameter based on a combination of the SSS and an associated cover code. For example, when a WTRU detects a first combination of the SSS and respective cover code (e.g. index corresponding to the delta offset), the WTRU may determine a first value for the Q parameter. When the WTRU detects a second combination of the SSS and respective cover code, the WTRU may determine a second value for the Q parameter. For example, the values for the Q parameter may be from a list, including but not limited to {1, 4, 8, 16, 24, 32, 48, 64, 72, 128, . . . }.

The WTRU may determine a maximum number of candidate SSB positions based on a combination of the SSS and an associated cover code. For example, when a WTRU detects a first combination of the SSS and respective cover code (e.g. index corresponding to the delta offset), the WTRU may determine a first value for the maximum candidate SSB block positions within an SSB burst. When the WTRU detects a second combination of the SSS and respective cover code (e.g. index corresponding to the delta offset), the WTRU may determine a second value for the maximum candidate SSB block positions within an SSB burst. For example, a WTRU may determine the maximum candidate SSB block positions within an SSB burst to be a first value (e.g. 64) in operation without shared spectrum channel access. The WTRU may determine the maximum candidate SSB block positions within an SSB burst to be a second value (e.g. 128 or more) in operation with shared spectrum channel access.

The WTRU may determine a discovery burst transmission window (DBTW) based on a combination of the SSS and an associated cover code. For example, a WTRU may determine that DBTW is enabled for an SSB burst transmission if the WTRU detects a first combination of the SSS and respective cover code (e.g. index corresponding to the delta offset) The WTRU may determine that DBTW is disabled for the SSB burst transmission if the WTRU detects a second combination of the SSS and respective cover code. The WTRU may determine that LBT is exempted in the SSB burst transmission (e.g. due to short control signaling) if the WTRU detects a third combination of the SSS and respective cover code.

The WTRU may determine a PBCH reception based on a combination of the SSS and an associated cover code. For example, when a WTRU detects a first combination of the SSS and respective cover code (e.g. index corresponding to the delta offset), the WTRU may receive the associated PBCH in a first mode of operation. When the WTRU detects a second combination of the SSS and respective cover code, the WTRU may receive the associated PBCH in a second mode of operation. One or more payload bits of the PBCH (e.g. MIB) may be interpreted differently based on the mode of operation. A PBCH time/frequency location may be determined based on the mode of operation. Different PBCH DMRS may be used for PBCH reception based on the determined mode of operation. For example, if the WTRU detects a first set of waveform parameters, the WTRU may detect a PBCH DMRS based on a first sequence or sequence type (e.g. Zadoff-Chu sequence). If the WTRU detects a second set of waveform parameters, the WTRU may detect a PBCH DMRS based on a second sequence or sequence type. The WTRU may determine whether to apply DFT-s-precoding for decoding the PBCH. For example, if the WTRU detects a first set of waveform parameters, the WTRU may decode the PBCH by assuming the PBCH is pre-coded with DFT-s-precoding. If the WTRU detects a second set of waveform parameters, the WTRU may decode the PBCH by assuming the PBCH is not pre-coded with DFT-s-precoding.

The WTRU may determine an SSB block configuration based on a combination of the SSS and an associated cover code. For example, the SSB block time/frequency location and/or maximum number of SSBs may be different based on the mode of operation. The WTRU may perform an SSB detection procedure based on the determined mode of operation. For example, in a case of operation with shared spectrum and based on a Q parameter, the WTRU may monitor candidate SSB positions to detect SSB blocks that are transmitted with the same QCL relation as the missed SSB blocks (e.g. due to LBT failure).

The WTRU may determine CORESET #0 and Type-0 PDCCH search space monitoring based on a combination of the SSS and the associated cover code. For example, when a WTRU detects a first combination of the SSS and respective cover code (e.g. index corresponding to the delta offset), the WTRU may use a first set of parameters for detection of the CORESET #0 and Type-0 PDCCH monitoring. When the WTRU detects a second combination of the SSS and respective cover code, the WTRU may use a second set of parameters for detection of the CORESET #0 and Type-0 PDCCH monitoring. For example, in a case of operation with shared spectrum channel access, parameters such as the number of symbols, number of RBs, RB offset values, and multiplexing pattern, may be selected from a first set of parameters and/or indexed tables. In a case of operation without shared spectrum channel access, the parameters may be selected from a second set of parameters and/or indexed tables. In another example, the WTRU may receive a Type-0 PDCCH search space configuration when the WTRU received or detected a first combination of the SSS and respective cover code (e.g. index corresponding to the delta offset). Full or partial configuration information for a Type-0 PDCCH search space may be predefined or pre-configured when the WTRU received or detected a second combination of the SSS and respective cover code.

The WTRU may determine sensing before transmission based on a combination of the SSS and an associated cover code. For example, a WTRU may perform channel sensing (e.g. listen before talk (LBT)) before transmission based on the mode of operation. For example, a WTRU may perform LBT before an uplink transmission (e.g. PUSCH, PUCCH, PRACH, SRS) when the WTRU detects a first combination of the SSS and respective cover code (e.g. index corresponding to the delta offset). The WTRU may not perform LBT before an uplink transmission when the WTRU detects a second combination of the SSS and respective cover code. The WTRU may consider LBT exemption, for example, due to short control signaling or COT sharing, in an uplink transmission when the WTRU detects a third combination of the SSS and respective cover code. For example, in operation with shared spectrum, a WTRU may perform single LBT sensing in an uplink transmission when the WTRU detects a first combination of the SSS and respective cover code (e.g. index corresponding to the delta offset). The WTRU may perform directional LBT and/or per-beam LBT sensing in an uplink when the WTRU detects a second combination of the SSS and respective cover code.

The WTRU may determine a duplex mode based on a combination of the SSS and an associated cover code. For example, a WTRU may determine a first duplex mode (e.g. TDD) when the WTRU detects a first combination of the SSS and respective cover code (e.g. index corresponding to the delta offset). The WTRU may determine a second duplex mode (e.g. FDD) when the WTRU detects a second combination of the SSS and respective cover code.

In an embodiment, one or more combination of an SSS and a respective cover code (e.g. index corresponding to the delta offset) may be used. A WTRU may determine at least one of following based on a combination and/or association of the SSS and the respective cover code: licensed spectrum or unlicensed spectrum; PBCH type (e.g. which information is included in the PBCH); duplex mode (e.g. TDD, FDD, or HD-FDD); PRACH resource configuration; range of the system bandwidth; use case (e.g. sidelink, Uu, NTN, etc.); maximum uplink transmission power; barring of WTRU types (e.g. access baring of a certain WTRU types) (for example, a first type of WTRUs (e.g. a WTRU with a limited capability including reduced Rx antenna, smaller maximum bandwidth supported, lower maximum transmission power) may be not allowed to access the cell when the SSB is located in a first Sync raster set, otherwise, the first type of WTRUs may be allowed to access the cell); and support of a specific functionality in the network (e.g. power saving, carrier aggregation, DRX).

In an embodiment, a WTRU may report and/or recommend one or more of the waveform parameters or parameter sets for one or more signals and/or channels. The one or more signals and/or channels may be one or more of the following: SS/PBCH block; CORESET possibly including CORESET #0 (i.e. Type0 PDCCH); SIB #1; PRACH; PDSCH; PUSCH; PUCCH; and reference signals (i.e. one or more of CSI-RS, DM-RS, CSI-RS for tracking, PT-RS, SRS).

The waveform parameters or waveform parameter sets may comprise one or more of the following: waveform multiplexing scheme; number of clusters; and DFT size of cluster/cluster size.

The waveform parameters or waveform parameter sets may comprise a waveform multiplexing scheme. In an embodiment, a WTRU may report its preferred waveform multiplexing scheme. For example, the WTRU may recommend one or more of CP-OFDM or a single-carrier based waveform for the one or more signals and/or channels. In an example, the WTRU may recommend one or more of clustered DFT-s-OFDM, Nx-SC-FDMA, and DFT-s-OFDM.

The waveform parameters or waveform parameter sets may comprise a number of clusters. In an example, a WTRU may report its preferred number of clusters to be used, defined, configured, or determined for the one or more signals and/or channels.

The waveform parameters or waveform parameter sets may comprise a DFT size of a cluster/cluster size. In an example, a WTRU may report its preferred DFT size of cluster and/or cluster size. The WTRU may report one or more DFT sizes of clusters and/or the cluster sizes and each DFT size of cluster and/or cluster size may be associated with each cluster based on the reported number of clusters. Association between the reported DFT size of cluster and/or cluster size may be determined based on frequency positions of the clusters. For example, a first reported DFT size/cluster size may be associated with a first cluster with a lowest/highest frequency resources and a second reported DFT size/cluster size may be associated with a second cluster with a lowest/highest frequency resources.

In an embodiment, a WTRU may determine a power back-off or offset parameter for each waveform parameter set or as part of a waveform parameter set. The WTRU may determine a waveform parameter set applicable to a SS/PBCH transmission or other signal (e.g. CSI-RS) based on embodiments described herein, and apply a corresponding offset to a measurement taken on the SS/PBCH or other signal. The measurement may be, for example, at least one of: RSRP, RSRQ or CSI-RSRP for the purpose of cell reselection or reporting at L1 or RRC. The offset may be pre-defined for each possible waveform parameter set or signaled by higher layers, such as from system information.

In an embodiment, a WTRU may determine that first and second signals are transmitted from a same cell and/or have a quasi-co-location relationship (e.g. same spatial filter) for the purpose of cell detection, synchronization or measurements when parameters detected from the first and second signals are linked by a defined relationship. The detected parameters may include at least one parameter defining a PSS or SSS sequence or a cover code. The WTRU may average measurement results from signals determined to be transmitted from the same cell.

In an example, a relationship may be that a WTRU determines that signals from which a same PSS and SSS sequence is detected are transmitted from the same cell even if the cover codes are different. For example, the WTRU may determine that signals from which a first and second cover codes are detected are transmitted from a same cell if first and second detected PSS sequences are the same and if a second detected SSS sequence index is an offset plus the first detected SSS sequence index. The offset may be pre-defined.

In an embodiment, a WTRU may determine a minimum offset and/or distance between the indexes associated with the reference sequences in synchronization signals (e.g. PSS and/or SSS). For example, a set of indexes may not be used for generation of PSS and/or SSS sequences. The WTRU may determine the minimum offset and/or distance based on the number of root indexes used for the cover codes. In an example, the minimum offset and/or distance may be more than or equal to the number of cover codes.

In an example, for M number of cover codes (e.g. delta offsets 0<δ_PSS≤M), the PSS root indexes u₁, . . . , uₚ may have an offset and/or distance equal to or greater than M.

The root indexes in between the root indexes used for synchronization reference sequences may be used, defined, configured, and/or determined as the root indexes for the associated cover codes (e.g. wₗ=uₖ+δ_PSS).

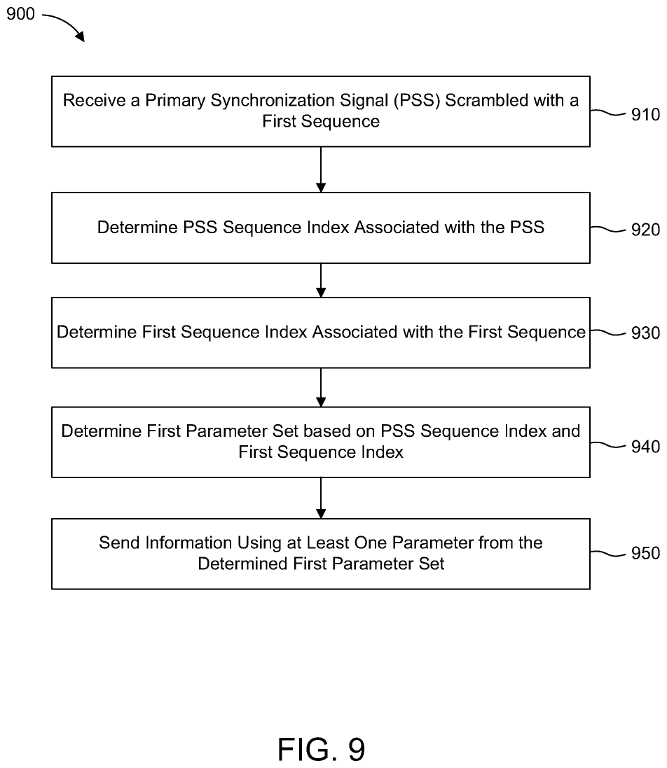

FIG. 9 shows an example of an SS/PBCH block configuration in initial access with hybrid waveforms. A WTRU may receive a primary synchronization signal (PSS) scrambled with a first sequence (910). The WTRU may determine a PSS sequence index (uₖ) associated with the PSS (920). The WTRU may determine a first sequence index (wᵢ) associated with the first sequence (930). The WTRU may determine a first parameter set based on the PSS sequence index (uₖ) and the first sequence index (wᵢ) (940). The WTRU may send information using at least one parameter from the determined first parameter set (950). The information may be a physical random access channel (PRACH) transmission. The first parameter set may be associated with a waveform. The first parameter set may comprise at least one of: an indication of a waveform type and an indication of a multiplexing scheme. The WTRU may determine a first offset based on the PSS sequence index (uₖ) and the first sequence index (wᵢ). The first parameter set may be determined based on the first offset. The first offset may be an index to a pre-configured table. The WTRU may receive a secondary synchronization signal (SSS) using at least one parameter from the first parameter set. The WTRU may determine a SSS sequence index (mᵢ) associated with the SSS and a second sequence index (nⱼ) associated with the second sequence. The WTRU may determine a second parameter set based on the SSS sequence index (mᵢ) and the second sequence index (nⱼ). The WTRU may send a PRACH transmission using at least one parameter from the second parameter set. The WTRU may determine a second offset based on the SSS sequence index (mᵢ) and the second sequence index (nⱼ). The second parameter set may be determined based on the second offset. The WTRU may receive information over a physical broadcast channel (PBCH) using at least one parameter from the determined first parameter set.

During an initial access, a WTRU may receive one or more synchronization signals. The synchronization signals may be part of a synchronization signal/physical broadcast channel (SS/PBCH) block. A gNB or cell may transmit one or more synchronization signals within an SS/PBCH block (SSB). In an example, a gNB or cell may transmit a primary synchronization signal (PSS) and a secondary synchronization signal (SSS). PSS, SSS, and synchronization signals may be used interchangeably herein.

In DFT-s-OFDM, the coded-modulated symbols may go through the DFT filter followed by the subcarrier mapping and IFFT module before transmission. In order for the synchronization signals to be detectable at the WTRU, Zadoff-Chu (ZC) sequences may be used. ZC sequences with length N may be defined by a respective root index and cyclic shifts. ZC sequences may have zero cyclic autocorrelation and cross-correlation may be as low as one over square root of the length Nzc. ZC sequences may have a very low peak-to-average power ratio (PAPR) and the amplitude may be the same before a DFT filter and after the DFT filter. The DFT of a ZC-sequence may be another ZC-sequence (i.e. a ZC sequence) and its DFT may be time-scaled conjugates of each other.

Upon successful detection of an SSB block, a WTRU may detect or determine a synchronization time and frequency offset based on the synchronization signals. The frequency offsets may be caused by misalignments of the local oscillators. The time offsets may be due to a channel delay spread. For example, the WTRU may detect the frequency offset based on the PSS, as the center frequency of the PSS corresponds to the center frequency of the respective synch raster (i.e. Global Synchronization Raster Channel (GSCN)). Therefore, a coarse frequency offset estimation may be accomplished with resolution of up to half of a subcarrier BW.

The WTRU may also detect the synchronization time offset based on the detected PSS. For example, the maximum likelihood estimation (MLE) may be used that may be accomplished by calculating the correlation of the received signal with the possible PSS sequences, where the spike at the output of the MLE module may reflect the synchronization time offset.

ZC-sequences are sensitive to the frequency offsets. As such, in a case where frequency offsets are present, the spikes may appear at the MLE's output for inaccurate time offsets, resulting in synchronization time misdetection. Therefore, further investigation is required to account for the synchronization time misdetections due to the impact of the frequency offsets.

Providing cover codes to overcome the effect of frequency offset in primary synchronization signals (PSS) is disclosed.

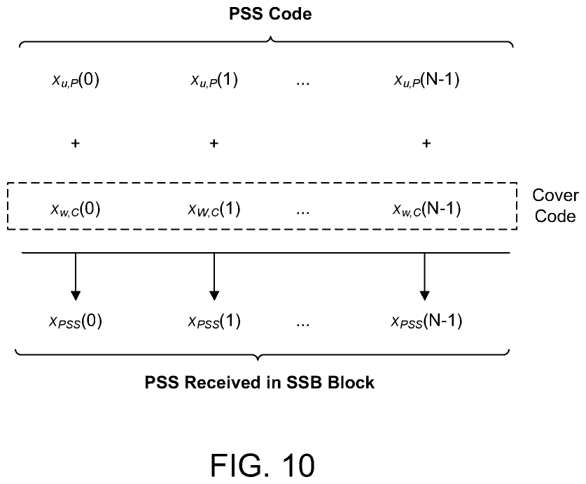

In an embodiment, a WTRU may receive a PSS code (e.g., x_{u,P}[n]), as part of an SS/PBCH block, that is scrambled with an associated cover code (e.g., x_{w,C}[n]), as part of an SS/PBCH block, as shown in FIG. 10. The WTRU may detect a PSS code based on a set of predefined root indexes corresponding to ZC-sequences of length N used in the PSS. For example, the WTRU may detect one of three PSS roots (u₁, u₂, u₃), where uᵢ∈{1, 2, . . . , N−1}.

The WTRU may determine a set of delta offset values that are associated with the detected PSS code. For example, the WTRU may be configured with M delta offset values (1, 2, . . . , M). The WTRU may determine the root index corresponding to the cover codes by adding the delta offset value (i.e. δ_PSS) and the PSS root index, where wᵢ=uᵢ+δ_PSS. The WTRU may detect a cover code based on the determined set of delta offset values. The cover code sequences may be generated based of the delta-offset values and the PSS root index (e.g. ZC-sequences of length N).

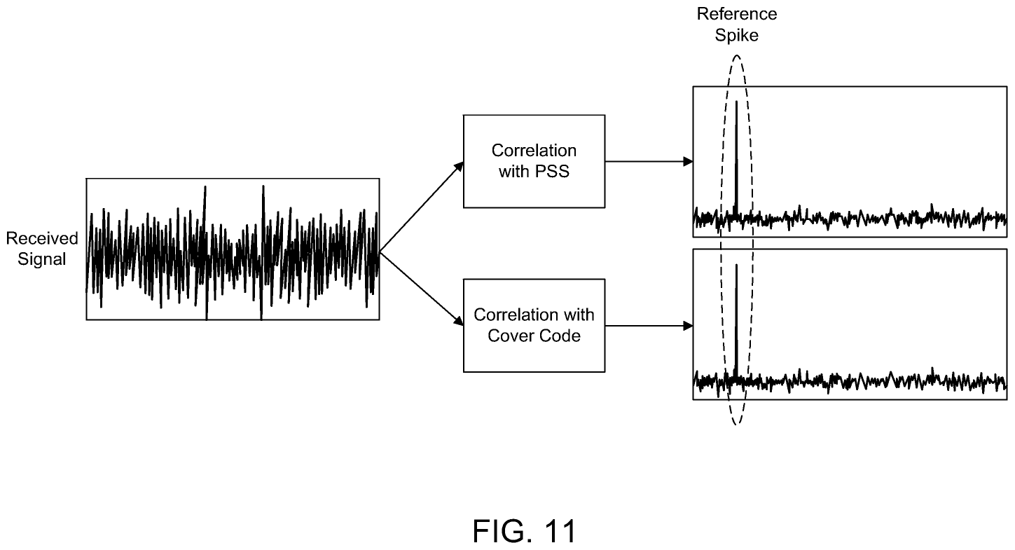

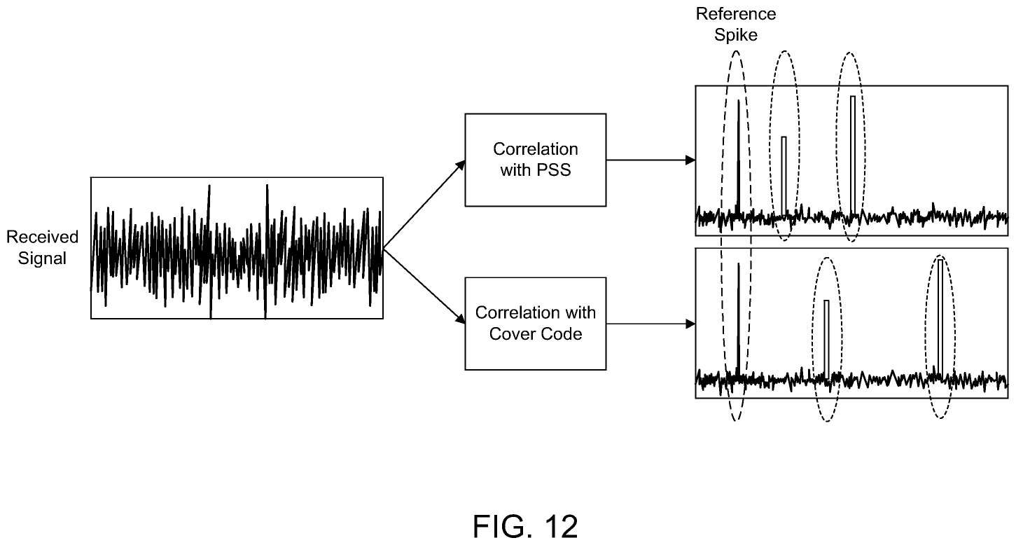

Upon successful detection of the PSS code, the WTRU may determine the synchronization time offset. The WTRU may determine the synchronization time offset based on the detected PSS cover code. The WTRU may determine the spikes at the output of the correlating module corresponding to the PSS code. The WTRU may determine the synchronization time offset based on the detected associated cover code. The WTRU may determine the spikes at the output of the correlating module corresponding to the associated cover code. If the synchronization time offset resulting from detection of the PSS code is the same as the synchronization time offset resulting from detection of the associated cover code, the WTRU may determine the exact time offset to be equal to the detected time offset from PSS and cover code, as shown in FIG. 11. If one or more of the synchronization time offsets resulting from detection of the PSS code are different from one or more of the synchronization time offsets resulting from detection of the associated cover code, the WTRU may determine the exact time offset to be equal to the time offset where both the PSS detection module and cover code detection modules show spikes at the output of their respective detection module, as shown in FIG. 12.

In an embodiment, a WTRU may monitor, receive, or attempt to decode a PSS in a respective SSB block. The WTRU may detect and/or determine that a first reference sequence (e.g. Zadoff-Chu sequence) is used for PSS generation.

One or more root indexes (e.g. {u₁, . . . , uₚ}) may be used, defined, configured, or determined for the sequences used in the PSS. Upon successful detection of the PSS, the WTRU may determine the root index (e.g. uₖ among {u₁, . . . , uₚ}) corresponding to the reference sequence in the respective PSS.

In an embodiment, one or more cover codes may be used, defined, configured, or determined. The cover codes may be associated with the determined PSS. For example, the root index in the cover codes may be associated with the determined PSS uₖ. The cover codes may have the same length as the PSS code and may be scrambled and/or symbol-by-symbol multiplied with the PSS sequence. The cover codes may be selected so that PSS may be detected with no interference and/or impact from the cover code. In an example, orthogonal and/or quasi-orthogonal sequences may be used as the cover code. For example, if the PSS is based on ZC-sequences with root index uₖ, the cover code may be generated based on a ZC-sequence with root index different from the respective PSS (e.g. wᵢ≠uₖ), as shown in FIG. 10.

In an embodiment, a WTRU may determine candidate cover codes based on one or more of the following: PSS sequence; PSS root index; frequency range; and license regime.

A WTRU may determine a set of candidate cover codes based on a PSS sequence. For example, the WTRU may determine a first set of candidate cover codes in a case where a first type of sequence is detected for the PSS (e.g. ZC sequence). The WTRU may determine a second set of candidate cover codes in a case where a second type of sequence is detected for the PSS (e.g. m-sequence).

A WTRU may determine a set of candidate cover codes associated with the detected PSS sequence. The WTRU may determine a set of root indexes for the candidate cover codes based on the detected root index for the PSS. For example, the sum of the detected PSS root index u and a set of delta offsets (e.g. 0<δ_PSS≤M) may be used as the set of candidate cover codes (e.g. w=u+δ_PSS) associated with the detected PSS.

A WTRU may determine a set of candidate cover codes based on a frequency range. In an example, a first set of candidate cover codes may be determined in a first frequency range, and a second set of candidate cover codes may be determined in a second frequency range. The first frequency range may be mutually exclusive to the second frequency range.

A WTRU may determine a set of candidate cover codes based on a license regime. In an example, a first set of candidate cover codes may be determined in a first license regime, and a second set of candidate cover codes may be determined in a second license regime.

In an embodiment, upon successful detection and/or decoding of the PSS code, a WTRU may determine a synchronization time offset based on the determined PSS. In an example, the WTRU may use a maximum likelihood estimation (MLE) to detect the time-offset corresponding to the synchronization time.

In an example, the WTRU may determine the output of the detection module (e.g. correlation and/or DFT module) of the received signal with the time shifted reference sequences. The spike at the output of the detection module may indicate the time synchronization offset.

A WTRU may determine the synchronization time offset based on the determined cover code. For example, the WTRU may use an MLE module to detect the time offset.

In an embodiment, a WTRU may compare the output results of the synchronization time offset detection corresponding to the PSS code and the cover code. In a case where a unique time offset is detected based on both the PSS and the cover code, the WTRU may determine a respective time offset as the reference synchronization time, as shown in FIG. 11. In a case where one or more time offsets are detected based on the PSS and/or cover code (e.g. due to the impacts from frequency offset), the WTRU may monitor the outputs and attempt to find the time offset that is the same in the output of both the PSS and cover code. The WTRU may determine the detected time offset as the reference synchronization time, as shown in FIG. 12.

In an embodiment, a WTRU may determine the differences and/or similarities at the output of the detection modules corresponding to the PSS and cover code. For example, the WTRU may multiply the outputs to remove the mis-detected spikes and/or time offsets. The WTRU may determine the reference synchronization time based on the output of the multiplying module, for example, based on the strongest or the one only remaining spike.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit/receive unit (WTRU), the method comprising:
receiving a primary synchronization signal (PSS) scrambled with a first sequence;
determining a PSS sequence index (uₖ) associated with the PSS;
determining a first sequence index (wᵢ) associated with the first sequence;
determining a first offset based on the PSS sequence index (uₖ) and the first sequence index (wᵢ);
determining a first parameter set based on the first offset; and
sending information using at least one parameter from the determined first parameter set.

2. The method of claim 1, wherein the first parameter set is associated with a waveform.

3. The method of claim 1, wherein the first parameter set comprises at least one of: an indication of a waveform type or an indication of a multiplexing scheme.

4. The method of claim 1, wherein the information is a physical random access channel (PRACH) transmission.

5. The method of claim 1, wherein the first offset is a delta offset, wherein the delta offset is a difference between the PSS sequence index (uₖ) and the first sequence index (wᵢ).

6. The method of claim 1, wherein the first offset is an index to a pre-configured table.

7. The method of claim 1, further comprising:
receiving a secondary synchronization signal (SSS) using at least one parameter from the first parameter set, wherein the SSS is scrambled with a second sequence.

8. The method of claim 7, further comprising:
determining a SSS sequence index (mᵢ) associated with the SSS;
determining a second sequence index (nⱼ) associated with the second sequence;
determining a second parameter set based on the SSS sequence index (mᵢ) and the second sequence index (nⱼ); and
sending a PRACH transmission using at least one parameter from the second parameter set.

9. The method of claim 8, further comprising determining a second offset based on the SSS sequence index (mᵢ) and the second sequence index (nⱼ), wherein the second parameter set is determined based on the second offset.

10. The method of claim 1, further comprising:
receiving information in a physical broadcast channel (PBCH) transmission using at least one parameter from the determined first parameter set.

11. A wireless transmit/receive unit (WTRU) comprising:
a transmitter;
a receiver; and
a processor, wherein:
the receiver is configured to receive a primary synchronization signal (PSS) scrambled with a first sequence;
the processor is configured to determine a PSS sequence index (uₖ) associated with the PSS;
the processor is further configured to determine a first sequence index (wᵢ) associated with the first sequence;
the processor is further configured to determine a first offset based on the PSS sequence index (uₖ) and the first sequence index (wᵢ);
the processor is further configured to determine a first parameter set based on the first offset; and
the transmitter is configured to send information using at least one parameter from the determined first parameter set.

12. The WTRU of claim 11, wherein the first parameter set is associated with a waveform.

13. The WTRU of claim 11, wherein the first parameter set comprises at least one of: an indication of a waveform type or an indication of a multiplexing scheme.

14. The WTRU of claim 11, wherein the information is a physical random access channel (PRACH) transmission.

15. The WTRU of claim 11, wherein
the first offset is a delta offset, wherein the delta offset is a difference between the PSS sequence index (uₖ) and the first sequence index (wᵢ).

16. The WTRU of claim 11, wherein the first offset is an index to a pre-configured table.

17. The WTRU of claim 11, wherein:
the receiver is further configured to receive a secondary synchronization signal (SSS) using at least one parameter from the first parameter set, wherein the SSS is scrambled with a second sequence.

18. The WTRU of claim 17, wherein:
the processor is further configured to determine a SSS sequence index (mᵢ) associated with the SSS;
the processor is further configured to determine a second sequence index (nⱼ) associated with the second sequence;
the processor is further configured to determine a second parameter set based on the SSS sequence index (mᵢ) and the second sequence index (nⱼ); and
the transmitter is further configured to send a PRACH transmission using at least one parameter from the second parameter set.

19. The WTRU of claim 18, wherein:
the processor is further configured to determine a second offset based on the SSS sequence index (mᵢ) and the second sequence index (nⱼ), wherein the second parameter set is determined based on the second offset.

20. The WTRU of claim 11, wherein:
the receiver is further configured to receive information in a physical broadcast channel (PBCH) transmission using at least one parameter from the determined first parameter set.
